(19) United States
(12) Patent Application Publication
(10) Pub. No.: US 2009/0319446 A1
(43) Pub. Date: Dec. 24, 2009

(54) Resonance Based Sales System and Method

(76) Inventor: Jody Leanne Fedor, Ottawa (CA)

Correspondence Address: MBM Intellectual Property Law LLP, 270 ALBERT STREET, 14TH FLOOR, OTTAWA, ONTARIO, K1P 5G8, CA

(21) Appl. No.: 12/469,453

(22) Filed: May 20, 2009

(30) Foreign Application Priority Data
May 20, 2008 (CA) 2632058

(51) Int. Cl. G06Q 90/00

(52) U.S. Cl. 705/500

(57) ABSTRACT

The invention provides a resonance based sales system and method. The system comprises a skin care and/or cosmetic product including natural ingredients and a package configured for association with the product. The system further includes an engaging message associated with one or more of the product and the package, the engaging message configured to elicit an emotional response of inspiration from a customer, wherein the emotional response is representative of the engaging message resonating with one or more aspects of a female archetype. The invention further provides a method for generating an engaging message which includes identifying an individual and a situation wherein the individual had displayed a personal perception of inadequacy. Subsequently, a message for the individual is developed, wherein the message is configured to elicit an emotional response of inspiration from the individual, such that the emotional response is representative of the message resonating with one or more aspects of a female archetype. Furthermore, the method comprises reconfiguring the message into a lyrical configuration, thereby generating the engaging message.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in the Patent and Trademark Office patent file or records, but reserves all other rights whatsoever.

### FIELD OF THE INVENTION

This disclosure relates generally to a packaging arrangement. More particularly, this disclosure relates to a packaging arrangement for use in advertising or marketing information and/or products.

### BACKGROUND

Advertising and marketing strategies are a necessary and desired aspect of provider-consumer interactions. The Provider needs to tell the consumer about the benefits of the service and/or product and the consumer desires to learn about the benefits and how this product and/or service is different from the others available in the marketplace.

A wide variety of marketing arrangements are utilized for packaging and displaying informational material. Informational material includes printed text, graphics, and sample products, for example. As can be understood, a consumer's interest in the informational material can be influenced by the packaging of the informational material. The likelihood that a potential consumer will take time to review and consider the contents of the packaging often depends upon whether or not the packaging sparks the interest of the consumer.

Advertising and packaging is generally designed to evoke a response or emotion in the consumer. Most people make unconscious assessments of a product, service, or event not only based on the item itself, but on secondary sensory input associated with the item, which all contribute to one general impression—whether intended or not, accurate or not. Louis Cheskin called this “sensation transference”. Cheskin's innovative insight was that impressions created in customers' minds, based on experiencing products sensorially, transferred directly to concepts of value, price, quality, and emotion. These, in turn, created and fulfilled expectations of satisfaction.

Traditional marketing strategies for personal products and services tend to emphasize the concept that—if the consumer buys or does something—then they will be more attractive, worthy or valuable, etc . . . Typical packaging describes the characteristics of the product and how it will somehow render the consumer better, generally promising results like “youthful skin forever,” “wrinkle-reducing,” “youth enhancing” and so on.

Other styles of packaging talk about the products being prepared with “Free-Trade” ingredients to tell the consumer that—if they buy this product—then they will be helping employ someone in the world. Although beneficial and social minded, the orientation of the message is still motivational.

Some shopping bags display phrases that are motivational. For example: “Wake up and realize you are surrounded by amazing friends;” “Your outlook on life is a direct reflection of how much you like yourself;” “To move forward in LIFE FORGIVE your parents for everything you THINK they did wrong,” and “Life is full of setbacks. Success is determined by how you handle setbacks.” These are motivational messages seeking to encourage the consumer to take action in order to get something; if they buy and use this product, then they will get something that will improve you life. This can create confusion in the consumers mind about what they need to do in order to achieve something that will improve their life.

In this manner, a constant message that is especially prevalent in consumer-cultures—is that a woman must buy and use a service or product in order to become thinner, have smoother silkier skin, have less wrinkles, look more “something,” and/or less “something else” and so on. Unfortunately, this strategy inherently perpetuates the concept that the woman is not good enough—that they need something else, external to themselves to be attractive and worthy (of attention, connection, etc.) These marketing strategies perpetuate the “dependency” aspect of female culture that women need something to “fix” themselves in order to be valuable. These marketing strategies have fostered an unintentional undermining of female self-esteem, endemic in many cultures.

Therefore there is a need for a new approach of communicating with a customer that they are beautiful in their essence. In particular, communicating with a customer in a manner that supports, rather than undermines their self esteem, while providing them with one or more products that celebrate their inherent beauty.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

This holistic system is designed to inspire a consumer of skin care and/or cosmetic products comprising a message, packaging and high quality product all designed to generate a sense of well-being in the consumer. These messages speak to the feminine archetype and therefore resonate with a large percentage of consumer women, encouraging women to discover (remember) and embrace their individual brilliance and their own unique beauty. The messages recognize, validate and support that which women already are; thereby inspiring in the consumer a feeling of immediate well being, acceptance, understanding and a sense of connection.

In some embodiments, the system comprises packaging with an exuberant design and color in addition to high quality product, reflecting a celebration of these attributes.

An object of the present invention is to provide a resonance based sales system and method. In accordance with an aspect of the invention, there is provided a resonance based sales system comprising: a skin care and/or cosmetic product including natural ingredients; a package configured for association with the product; and an engaging message associated with one or more of the product and the package, the engaging message configured to elicit an emotional response of inspiration from a customer, wherein the emotional response is representative of the engaging message resonating with one or more aspects of a female archetype.

In accordance with another aspect of the invention, there is provided a method for generating an engaging message configured to elicit an emotional response of inspiration, the method comprising: identifying an individual and a situation wherein the individual displayed a personal perception of inadequacy; developing a message for the individual which is configured to elicit an emotional response of inspiration from the individual, the emotional response representative of the message resonating with one or more aspects of a female archetype; reconfiguring the message into a lyrical configuration thereby generating the engaging message.

In accordance with another aspect of the invention, there is provided a resonance based sales method comprising: providing a skin care and/or cosmetic product including natural ingredients; providing a package configured for association with the product; and providing an engaging message associated with one or more of the product and the package, the engaging message configured to elicit an emotional response of inspiration from a customer, wherein the emotional response is representative of the engaging message resonating with one or more aspects of a female archetype.

### BRIEF DESCRIPTION OF THE FIGURES

FIG. 1 illustrates a resonance based sales system according to embodiments of the invention.

FIG. 2 illustrates an ornamentation of a package according to embodiments of the invention.

FIG. 3 illustrates an ornamentation of a package according to embodiments of the invention.

FIG. 4 illustrates an ornamentation of a package according to embodiments of the invention.

FIG. 5 illustrates an ornamentation of a package according to embodiments of the invention.

FIG. 6 illustrates an embodiment of a resonance based sales system according to an embodiment of the invention.

FIG. 7 illustrates an embodiment of a resonance based sales system according to an embodiment of the invention.

FIG. 8 illustrates an embodiment of a resonance based sales system according to an embodiment of the invention.

FIG. 9 illustrates an embodiment of a resonance based sales system according to an embodiment of the invention.

FIG. 10 illustrates an embodiment of a resonance based sales system according to an embodiment of the invention.

### DETAILED DESCRIPTION OF THE INVENTION

### Definitions

The terms “natural ingredients” is used to define one or more ingredients which are derived from natural sources. Furthermore, in some embodiments, natural ingredients can be organic ingredients.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

This holistic, resonance based system is designed to inspire a consumer of skin care and/or cosmetic products comprising a message, packaging and high quality product which includes natural ingredients, all designed to improve the quality and health of a consumer's skin and to generate a sense of well-being in the consumer. This system provides the objective of describing the benefits of the product and/or services, while supporting the self-esteem of the potential consumer, rather than undermining it. These messages speak to the female archetype and therefore resonate with a large percentage of consumer women, encouraging women to remember, discover and embrace their individual brilliance and their own unique beauty. For example, a female archetype can be a represented by one or more models or patterns of womanhood and feminine behaviour that are recognisable to us, and in some cases easily recognisable.

The one or more messages recognize, validate and support that which women already are; thereby inspiring in the consumer a feeling of immediate well being, acceptance, understanding and a sense of connection. In some embodiments, the system comprises packaging with an exuberant design and color in addition to high quality product, reflecting a celebration of these attributes.

A holistic approach to product packaging provides an authentic and congruent experience on all facets of the packaged product. An authentic message is one that conforms to reality and therefore is worthy of trust, reliance, or belief. The packaging is authentic and inspirational as are the contents. Authenticity requires “true” ingredients (i.e., natural and/or organic), advertising, messaging. The ingredients are natural and can be organic, so the contents are authentic.

In some embodiments, the packaging is exuberant (joyously unrestrained and enthusiastic; elaborate in style) and celebrates women remembering, discovering, and embracing their individual brilliance and their own unique beauty.

One of our deepest fears as a human is a sense of being disconnected from a tribe. In saying to a woman, “you are already perfect and we see this in you,” we are essentially saying that you belong, that you are good, that you are beautiful, and that “we understand”, this sense of support and positive acknowledgement leaves women with a sense of deep connection to the world (their human tribe).

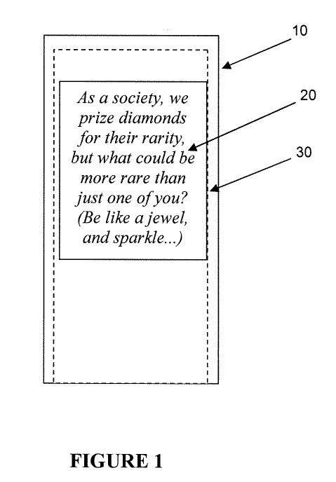

FIG. 1 illustrates a resonance based sales system according to embodiments of the invention. The system comprises a skin care and/or cosmetic product 30 including natural ingredients and a package 10 configured for association with the product. As illustrated in FIG. 1, the product 30 is illustrated by dashed lines as it has been placed within the package 10. The system further includes an engaging message 20 associated with one or more of the product and the package, the engaging message configured to elicit an emotional response of inspiration from a customer, wherein the emotional response is representative of the engaging message resonating with one or more aspects of a female archetype.

The invention further provides a method for generating an engaging message, which is configured to elicit an emotional response of inspiration. The method includes identifying an individual and a situation wherein the individual had displayed a personal perception of inadequacy. Subsequently, a message for the individual is developed, wherein the message is configured to elicit an emotional response of inspiration from the individual, such that the emotional response is representative of the message resonating with one or more aspects of a female archetype. Furthermore, the method comprises reconfiguring the message into a lyrical configuration, thereby generating the engaging message.

In some embodiments, the system further comprises or collection means or mechanism for collection of one or more customer's comments regarding one or more engaging message. Through the collection of comments relating to the one or more engaging messages, a user of the resonance based sales system can optionally determine a respective message's effectiveness and develop and/or modify one or more of the engaging messages.

In some embodiments, the collection means can further provide for the collection of desires or general comments from the one or more customers, wherein these desires and/or comments can be used for the development of one or more engaging messages.

### Inspirational Message

The one or more inspirational messages or engaging messages speak to the female archetype and therefore resonate with a large percentage of women. The origins of the archetypal hypothesis date back as far as Plato. They were collective in the sense that they embodied the fundamental characteristics of a thing rather than its specific peculiarities. Archetypal messages speak to the commonalities of female brilliance and beauty: common truths pertaining to women.

This fact that the engaging message resonates with the consumer reflects that the creator of the message understands them, albeit sometimes at a deeply buried level. The messages are authentic, for example the engaging message resonates with one or more aspects of the female archetype. If the words did not “ring true” on some level, the message would not have its impact; it would not inspire the consumer to somehow feel better about themselves, especially without having to do anything in order to be recognized as valuable and worthy.

Recognizing the personal brilliance within rather than saying that someone must do or be something different than they already are to achieve happiness of success, these messages recognize and validate and support that which they already are; thereby inspiring in the consumer a feeling of immediate well being and acceptance and a sense of connection and understanding. Being seen and recognized and validated, a woman could feel a sense of connection to others.

In some embodiments, the following steps are followed to generate an inspirational message or engaging message. The individual generating the message should:
a) think of someone they know and a situation in which they have seen this person discount themselves or displayed a personal perception of inadequacy;
b) think of what they would say to them if speaking to their core (based on a knowledge of core emotional states of humans, for example the female archetype), thereby developing a message for that person which would elicit an emotional response of inspiration;
c) write, reconfigure or transform this message into a lyrical configuration resulting in the generation of the inspirational message or engaging message. For example, an engaging message formed based on a lyrical configuration can express one or more deep personal emotions or observations. In some embodiments, a lyrical configuration can be highly enthusiastic. Other lyrical configurations would be readily understood by a worker skilled in the art.

In some embodiments, an engaging message is configured to highlight positive elements or traits in a individual. In some embodiments, an engaging message is configured to celebrate that “which already is” in an individual. In some embodiments, an engaging message is configured to encourage an individual to purchase a product because they deserve the best in their life. In some embodiments, an engaging message is configured to tell an individual that they already have exactly what they need within.

In some embodiments, the inspirational or engaging message is written in a first person plural configuration, for example “we”. In this configuration, the engaging message provides a sense of unity or companionship for the inspiration. This may provide a means for the individual to realise that they are not alone.

In some embodiments, the engaging message can be printed, screened, adhered or by produced by other reproduction means, on the package or packaging. In some embodiments, the engaging message is produced on a separate component, for example an insert, which can be placed within the package or the packaging.

According to embodiments, the following are examples of inspirational or engaging messages. These examples represent a sample of potential engaging messages and are not intended to be limiting in any way.

Open Love Letter #32

Wooooooooooheeeeeeeeeeee! You're a laser-pointing beam, a sharp-cutting sword, a hurdle-swallowing goddess, a single firefly in a nighttime meadow. Your intensity reminds us of our own strength, and the world needs more women like you who are unafraid to claim their power. It's a gift you offer freely, and part of a beauty that goes far deeper than your physical self (although that's rather a vision too).

Open Love Letter #12

As a society, we prize diamonds for their rarity, but what could be more rare than just one of you? (Be like a jewel, and sparkle . . . )

Open Love Letter #21

We'll agree—we don't know what you look like, about the cut of your hair or the turn of your cheek, but we without-a-doubt know that there is something about you that is heartbreakingly pure and elegant in its truth. And this, my dear - makes you absolutely—well—lovely. (shine on, glamour-girl, shine on)

Open Love Letter #1

You rise to a challenge, win against the odds, and triumph when the going gets tough; and you do it all with optimism in your heart and a song on your lips. Wow. To us, you are faith in action and a reason to believe that the world is always a place of laughter and light. (thank you)

Open Love Letter #22

You're a warrior with a cause, quick to leap into battle to protect what you believe in. You're strong, but you may have noticed the sideways glances when you fight too hard or long.

It's because in your passion you don't follow the same safe rules others do: “be nice, don't get noticed, conform”.

Most don't yet have the faith in themselves that you do, and the possibility and fire of it all scares them. But don't stop. Please, don't stop, even when they are convincing in their fear.

Because what a leader and teacher you are; a lifetime lesson of what is possible, and of what we can become.

Open Love Letter #25

What's a real miracle? Living and laughing and playing, being scared and doing it anyway, coming smack up against our own boundaries and pushing on further, forgetting what boredom is, learning to love just a little deeper and a little truer, recognizing our own vast capacity for goodness and finally, seeing the immense potential that lies within each of us. Now that's a good fit for the word ‘miracle’

Open Love Letter #2

What if you are as full of possibility as you suspect you might be? We see the sun, moon and all the constellations sitting inside of you; a vast, brilliant ocean of light, patiently waiting for the day you set it free. (you'll be radiant)

Open Love Letter #8

It can be hard to be different from the people around you. But consider this: everything great and wonderful in this big bold world of ours is the result of someone thinking differently from the people around them. For genius to flourish, often all it takes is a little bravery, a lot of faith, and the confidence to trust your heart. (can you imagine the possibilities?)

Open Love Letter #19

Real love is raw, glorious, beautiful; an ever-changing evolution designed to stretch, challenge and allow us to grow and become our best selves. (whether you are talking about loving yourself or someone else!) p.s. all we need is love.

Open Love Letter #14

You are already exactly the person you are meant to be, in all your rough, tumble and vibrant glory. In years to come, you will change and grow, and still you will be exactly as you are meant to be: beautiful and loving; a passionate work in progress.

Open Love Letter #6

Your whole life you've been told to watch your step, don't do anything stupid, and to be careful. People mean well, but what if now is the time to walk before you look, take a chance on a foolish dream, and throw caution to the wind? Actually, the answer to that is easy; it's far past the time, so please get started, and don't be late . . . (you won't believe the life that's waiting)

Open Love Letter #16

And when she was good . . . Being the ‘good-girl’ is overrated. Too often you end up a pale version of what you could be; pleasing and sweet and pallid, and oh-so ‘nice’. Forget about everyone else and get naughty, get fearless, and get moving on your own unique life (we'll see great things from you)!

Open Love Letter #34

You're quirky and funny and free, and the idea that you should wait until someone else decides you should have flowers is one of the craziest things we've ever heard. Pick a daisy, grow a peony and buy the biggest bouquet you've ever seen; you deserve every twisting stem, every curling leaf, and every delicate flower (×10, of course).

Open Love Letter #97

There is a deep peace in knowing your voice, loving yourself and knowing that the world does not define you, but your reaction to it does. It's a soul-deep soothing that comes from knowing that you are meant to be here, just as you are, in this moment and in your skin. (and loving it!)

Open Love Letter #87

Whatever your mode of expression, we're all artists, creating a masterpiece with every word we speak and every moment we exist. And what could be more fresh and inspired than a piece of art that is the first of its kind and impossible to duplicate? (You're what they call a ‘limited edition of one’)

Open Love Letter #7

Even the strongest of us can get caught up trying to meet the expectations of the world around us. Remember, in moments of silence, deep in your core, lies your true authentic self, and it knows that you are already absolute perfection. Without doing a thing. (yeah—you know it)

Open Love Letter #43

Like the Chrysalis phase of a butterfly's life, you're in the midst of a transformation . . . Because, you brave and brilliant soul, scary as it is sometimes, you know it takes a little ‘out-with-the-old’, ‘in-with-the-new’ to uncover the real you . . . and learn to fly.

Open Love Letter #4

To see truth in your body, you must look closely at all your rough bits and textures and lines and bumps, and know that you live and breathe and laugh and cry and walk and love. And only you do it in just your way. Now that's beautiful, no matter what your size, color, shape or age. And that's the truth. (you sing it, sister)

Open Love Letter #33

There is a gentleness and passion in you that brings out the best in the people around you; you remind us that we are all connected. This gives you the power to make the world a kinder place, something it desperately needs. Whoever said that magic doesn't exist in this world hasn't yet seen you in action. (Abracadabra!)

Open Love Letter #17

When we speak of loving yourself, we often forget to mention one of the most important elements of self care—taking care of your body. And your body, my dear . . . well, let us just say, va va voom . . . it is well worth looking after! Please eat well, use healthy products, and think happy thoughts (very important, that last one) . . . and we'll see you in 2053! (dancing shoes will be needed at that meeting)

Open Love Letter #19

As we are seeking out the opinions of others, we often forget to listen to the gentle voice inside of us that already knows our own true worth. Don't forget to listen to the real expert on you: you. (there is no one better qualified)

Open Love Letter #85

A wise women once said “it is not who we say we are that matters, it is how we are that counts. You're a perfect example of this. It's not that you make perfect choices all the time (thank goodness, how boring); but you live to the ‘how’. You know your values, recognize their truth for you, and always return, right back on course, pointing due north, navigating as if you had never strayed. (we want the compass you're carrying)

Open Love Letter #38

We question ourselves: am I pretty enough, good enough, strong enough? On a grand, universal, bigger-than-our-own-backyard sort of way, each of us always was and always will be perfect and beautiful. (in any skin)

Open Love Letter #10

When the public's perception can turn on a dime, an exuberant woman knows that the only reality that truly matters is the one that contains a hot bubbly bath, Exuberance bath products, soulful music and a great glass of wine. That, and the conviction to know that her own opinion of herself is the only one that truly matters. (and just in case you need it . . . have we mentioned that we are your #1 fans?)

Open Love Letter #3

A Poem For You: Pretty is as pretty does, and you're doing some pretty things we love. (Roar, little kitten, roar)

### The Exuberant Packaging

The resonance based sales system comprises a package configured for association with the product. For example, the package can be open ended or closed ended and can be box, tube or other shaped package. In some embodiments the package can be form fitted to the product or the container or dispenser within which the product is contained.

In some embodiments, the packaging can have an exuberant design and colour in addition to high quality product, reflecting a celebration of the archetypal attributes of feminine beauty. The packaging is designed to stimulate the senses. The colours are bright and saturated and reflective of colours found in nature without being overly harsh or jarring to the eye. The design has a slightly three-dimensional appearance created by the overlay of the pattern which provides visual depth, as though the consumer could reach through the design to the product beneath. The gold highlighted on the front of the package gives the design a textured look which makes the consumer want to touch the packaging. Prior to opening the package the consumer can almost anticipate the smell of the product by the choice of the colours used. Light spring-like colours are used to reflect fresh crisp scents such as lemon and lavender and darker autumnal colours are used to reflect warmer lingering scents such as cinnamon.

In some embodiments, the exuberant designs tend to be whimsical, with colours that are bright and cheery to create a visual impact to sustain and enhance the customer's interest. The colours are selected to attract the customer's eye and to convey the message of what the product is all about. The colours selected reflect the ingredients contained within the product to further create a complete sensory experience for the consumer. The design on the outer surface of the package is highlighted by a thin strand of gold and gold shapes entwined throughout the floral design on the outer surface of the package to capture and reflect light and highlight the saturation of the colours. The use of gold highlights also emphasizes the richness of the product contained within and further speaks to the consumer being deserving of such a high quality product simply for being who they are.

In some embodiments, the designs are based on and/or incorporate plant and floral life, reflective of the natural ingredients but are also whimsical in appearance to further stimulate the creative and imaginative spirit within the consumer. The plant and floral life design of the packaging is reminiscent of a wild and tangled garden free to grow without any one focal point and yet the design is harmonious throughout by the use of a similar colour palette (cool tones versus warm tones) and unity in the smooth flowing nature of the shapes. The combination of the design which appears to flow off the side of the package combined with some shapes being outlined and others left as shadows creates the impression that each package was uniquely formed from a larger overall tapestry. This further emphasizes the uniqueness of the consumer and the celebration of individuality put forth by the product.

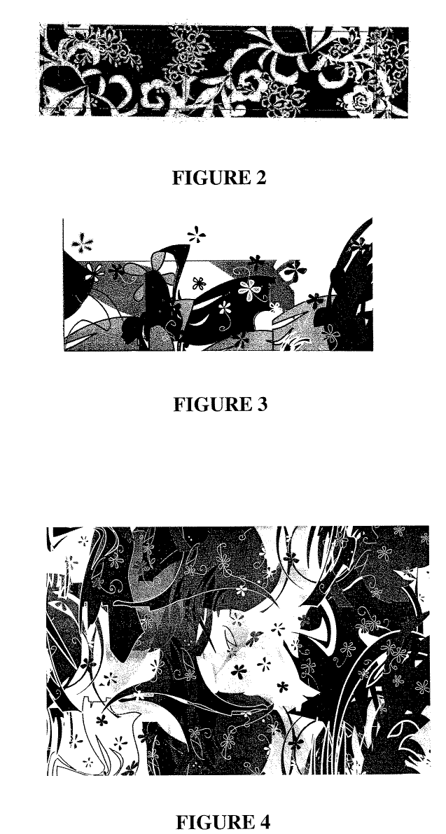

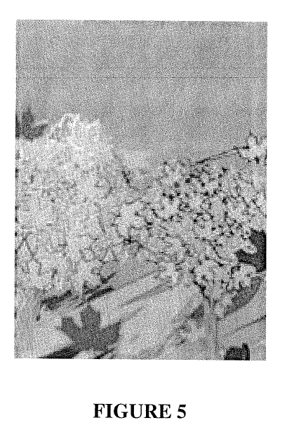

FIGS. 2 to 5 illustrate examples of the ornamentation of a package according to embodiments of the invention.

### The Product

The product is a skin care and/or cosmetic product which includes natural ingredients. For example, the product can be a cream, liquid, mask, gel or other form of skin care and/or cosmetic product. In embodiments, the product can be pure, effective, powerful skin care treatment to help skin look its best.

In some embodiments, a product can be made with between 70% to 98% or other range of organic ingredients, for example certified organic ingredients. Furthermore the product can be created with natural plant extracts, bioactive botanicals and pure essential oils. In some embodiments, each product is free of parabens, petroleum by-products and synthetic colors or fragrances.

According to some embodiments, the following defines a variety of skin care and/or cosmetic products including natural ingredients. These examples represent a sample of potential product ingredients and are not intended to be limiting in any way.

Organic Aloe Vera Leaf Juice

Extract of the Aloe Vera plant. Excellent hydrating, softening and soothing properties, especially for dry, damaged skin. It is a main component of our Neroli & Meadowfoam Smoothing Body Lotion.

Acerola Cherry

A small, bright-eyed cherry with a vitamin C content of up to 65% more than an orange. Vitamin C is essential for maintaining your skin's smoothness and elasticity. Found in our Acerolo Cherry & Willow Bark Toner.

Apricot Kernel Oil

With its high vitamin A content, Apricot Kernel oil is ideal for dehydrated and sensitive skin

Organic Black Willow Bark Extract

The original source of salicylic acid (the precursor to aspirin), studies have shown that natural black willow bark is effective against acne and acts to detoxify and soothe irritated, inflamed skin.

Carbomer

A mineral-derived ingredient that helps to bond oil to water to thicken your lotions to a rich, luxurious consistency.

Citric Acid

Naturally occurring in citrus fruits, this alpha-hydroxy acid increases cell turnover so that skin becomes smoother and more even toned with less wrinkles.

Organic Coconut Oil

A non-comedogenic oil good for dry, sensitive skin.

Natural DMAE

Known in cosmetic circles as a ‘facelift in a jar’ this naturally occurring wonderkid is one of the first ingredients proven to have a dramatic effect on sagging facial skin, one of the main contributors to visible aging.

Emulsifying Wax NF

A vegetable-based wax used to emulsify creams and lotions.

Evening Primrose Oil

Uniquely rich in gamma linolenic acid evening primrose oil encourages cell regeneration, resulting in young looking skin with a rich, plush appearance.

Grapeseed Oil

Rich is vitamins, minerals and linoleic acid, this light, non-greasy oil gently nourishes skin.

Organic Green Tea Leaf Extract

Active antioxidants repair sun-damaged skin while reducing puffiness.

Kosher Vegetable Glycerin

A naturally occurring vegetable emollient that acts overtime to soothe, protect and moisturize your skin.

Organic Geranium Oil

This mood-uplifting oil is reputed to help balance and calm all skin types.

Hydrolyzed Silk

Natural silk proteins penetrate the skin to moisturize creating smooth, silky skin.

Jojoba Oil

This gentle oil rapidly penetrates your skin to restore elasticity, soften, moisturize and heal.

Organic Lavender Oil

The essential oil of the lavender plant is well known for its ability to calm and soothe both the skin and soul. The extracts of this aromatic flower are also able to restore balance and initiate healing is damaged and stressed skin.

Meadowfoam Seed Oil

Extremely moisturizing, meadowfoam seed oil rapidly and enduringly adds moisture to skin made brittle by daily exposure to sun, wind and environmental stressors.

Organic Neem Oil

Often referred to in India as the village pharmacy, the oil of the Neem tree seed is has been used for centuries because of its ability to gently prevent acne and moisturize skin with fatty acids and glycerides.

Neroli Oil

An extract of the bitter orange tree flower, neroli is believed to regenerate cells and improve skin elasticity. A favorite component in perfumes, the pure oil is reputed to relieve depression, shock and panic.

Pro-Vitamin B5

Improves and increases the water retention capacity of the skin so that dry skin stays supple and elastic long after lotion has been applied.

Palm Stearic Acid

Naturally occurring in palm oil. Palm oil increases the moisture-retention capacity of the skin so that skin stays supple and elastic.

Polysorbate 20

Using oleic acid created from an olive oil source, this gentle synthetic ingredient is used to safely disperse essential oils and emulsify lotion and toners.

Pineapple Extract

This sweet fruit contains proteolytic enzymes that help stimulate and cleanse inflamed, sore skin. This ingredient is found in our Acerola Cherry & Willow Bark Fresh Facial Toner.

Rosemary Extract

Derived from natural sources, this antioxidant protects the oils in natural product formulations with its strong anti-microbial qualities.

Indian Rose

Harvested in the upper regions of India, rose oil is prized as much or its effectiveness as it is for its scent. One of the costliest of all essential oils, rose is a superpower at reducing redness, balancing uneven skin texture and reducing fine lines.

Rose Hydrosol

A mild astringent good for toning all skin types. Believed to have restorative powers for maturing skin.

Shea Butter

Also known as African Karite butter, this marvelously luxurious butter is extremely moisturizing and gentle to skin.

Sweet Almond Oil

Native to Asia and the Mediterranean, the oil of the sweet almond nut is rich with nutrients that soften and condition dry skin.

Tangerine Oil

The energetic scent of tangerine is reputed to not only help to awaken and reenergize, the oil helps to reduce fluid retention and increase circulation for a lively, youthful appearance.

Witch Hazel Distillate

The bark of this deliciously twisted shrub is used as a toning agent to tighten the tissues and reduce broken capillaries.

Vitamin E

An antioxidant with a proven anti-aging effect on the skin.

Verbena Oil

This essential oil is reputed to banish the blues and depression while softening and smoothing skin. Its positive effects can be found as part of the essential oil blend in our Neroli & Meadowfoam Smoothing Body Lotion.

Vitamin C

A natural antioxidant that fights damaging free radicals by strengthening collagen and elastin in the deepest layer of the skin.

The invention will now be described with reference to specific examples. It will be understood that the following examples are intended to describe embodiments of the invention and are not intended to limit the invention in any way.

### EXAMPLES

### Example 1

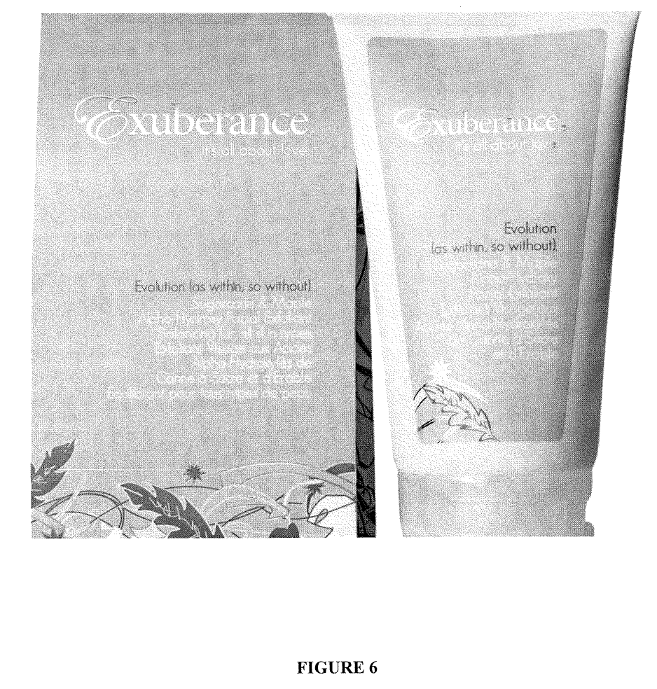

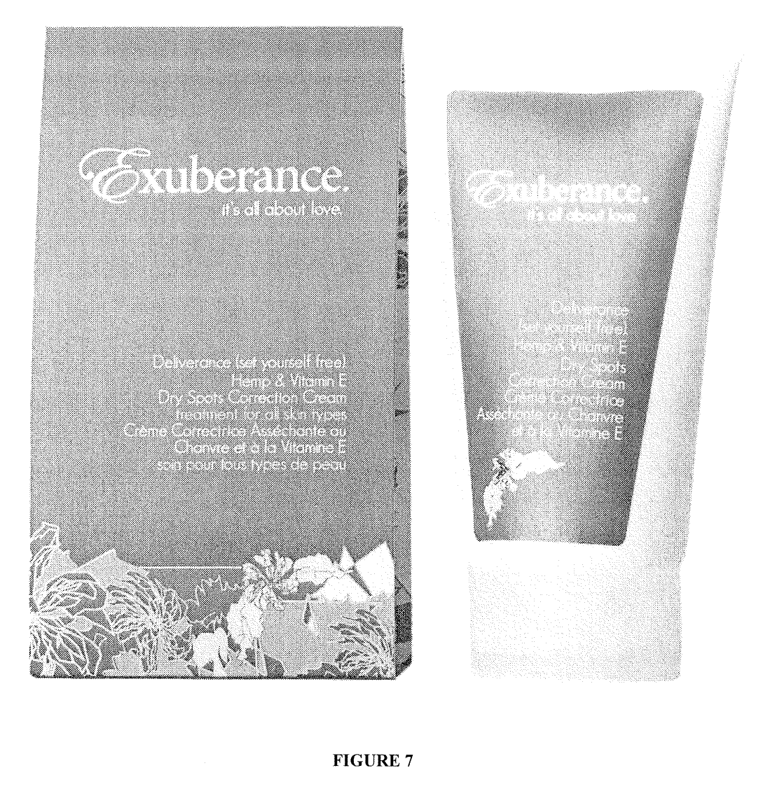

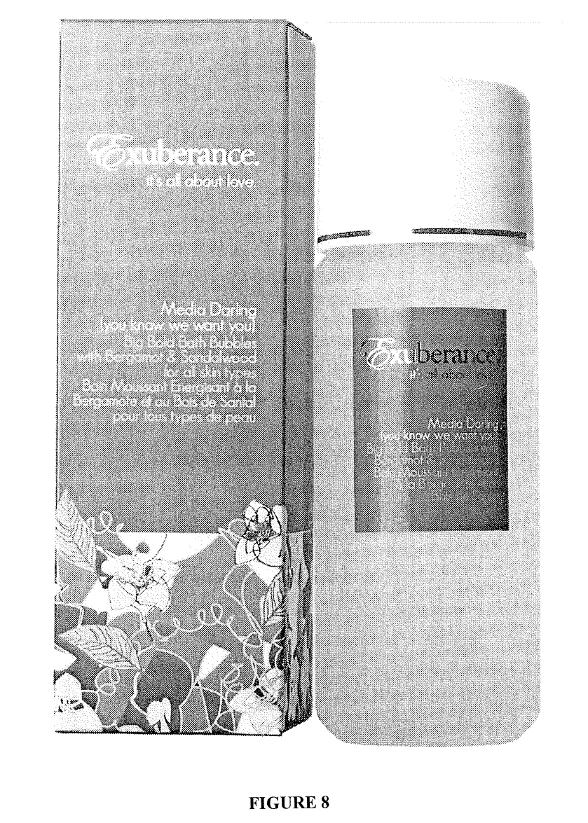

FIGS. 6, 7 and 8 illustrate examples of resonance based sales systems according to various embodiments of the invention. The system comprises a skin care and/or cosmetic product 130, 330 and 530 including natural ingredients and a package 110, 310 and 510 configured for association with the product. The system further includes an engaging message 120, 320 and 520 associated with one or more of the product and the package, the engaging message configured to elicit an emotional response of inspiration from a customer, wherein the emotional response is representative of the engaging message resonating with one or more aspects of a female archetype.

### Example 2

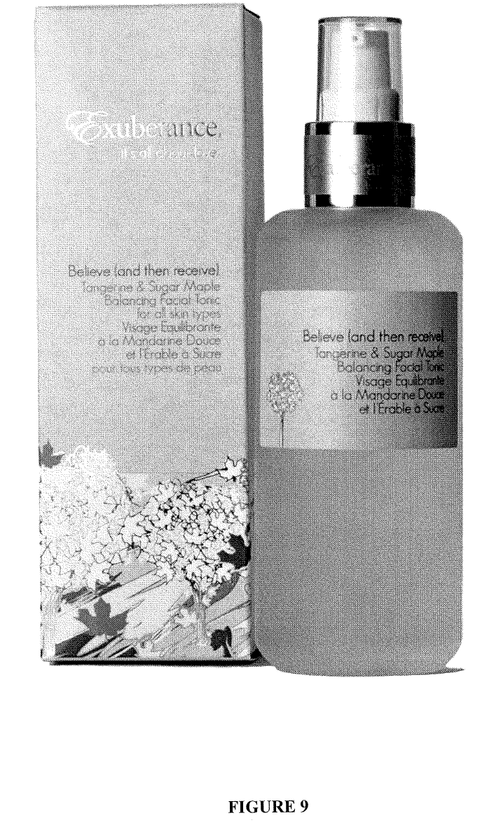

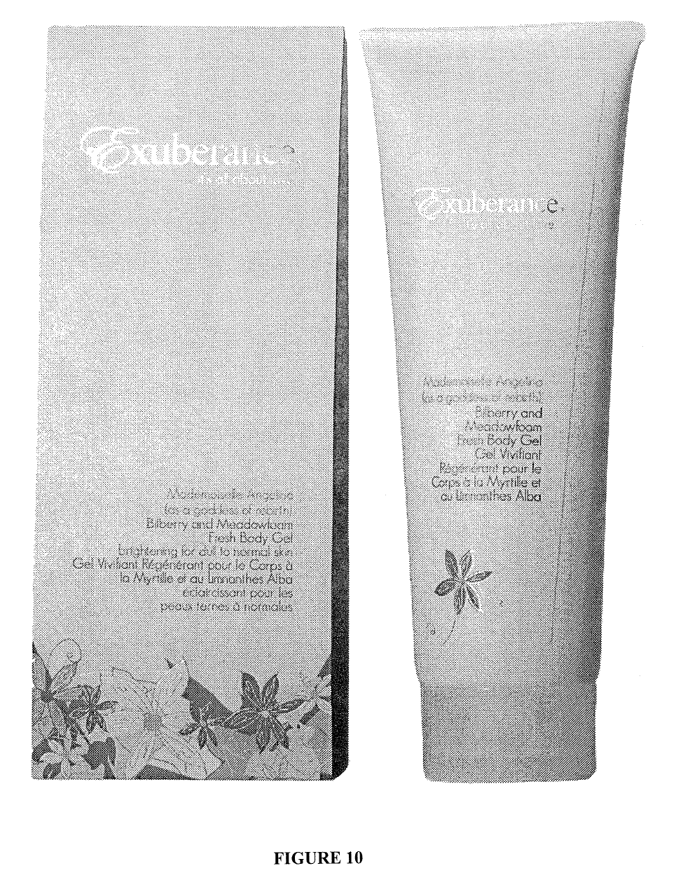

FIGS. 9 and 10 illustrate examples of resonance based sales systems according to further embodiments of the invention. The system comprises a skin care and/or cosmetic product 230 and 430 including natural ingredients and a package 210 and 410 configured for association with the product. The system further includes an engaging message 220 and 420 associated with one or more of the product and the package, the engaging message configured to elicit an emotional response of inspiration from a customer, wherein the emotional response is representative of the engaging message resonating with one or more aspects of a female archetype. Furthermore, a secondary engaging message 225 and 425 is associated with the product or the container in which the product is contained. In some embodiments of the invention, the secondary engaging message is the same as the engaging message 220 and 420 associated with the package.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A resonance based sales system comprising:
a) a skin care and/or cosmetic product including natural ingredients;
b) a package configured for association with the product; and
c) an engaging message associated with one or more of the product and the package, the engaging message configured to elicit an emotional response of inspiration from a customer, wherein the emotional response is representative of the engaging message resonating with one or more aspects of a female archetype.

2. The system according to claim 1, wherein the engaging message is printed, screened or adhered to the package or the product.

3. The system according to claim 1, wherein the engaging message is presented to the customer on a component inserted within the package.

4. The system according to claim 1, further comprising a collection means for collection of one or more customer comments relating to the engaging message.

5. The system according to claim 1, wherein the package is configured to stimulate one or more senses of the customer.

6. The system according to claim 1, wherein the package is configured using one or more bright, saturated colors.

7. The system according to claim 1, wherein the package is representative of one or more of the natural ingredients.

8. The system according to claim 1, wherein the engaging message is associated with the package and the product.

9. The system according to claim 1, wherein a first engaging message is associate with the package and a second engaging message is associated with the product.

10. A method for generating an engaging message configured to elicit an emotional response of inspiration, the method comprising:
a) identifying an individual and a situation wherein the individual displayed a personal perception of inadequacy;
b) developing a message for the individual which is configured to elicit an emotional response of inspiration from the individual, the emotional response representative of the message resonating with one or more aspects of a female archetype;
c) reconfiguring the message into a lyrical configuration thereby generating the engaging message.

11. The method according to claim 10, wherein the lyrical configuration is highly enthusiastic.

12. The method according to claim 10, wherein the lyrical configuration expresses one or more deep personal emotions or behaviors.

13. The method according to claim 10, wherein the engaging message is configured to identify one or more positive elements or traits of the individual.

14. The method according to claim 10, wherein the engaging message is presented in a first person plural format.

15. The method according to claim 10 wherein the engaging message is configured to tell the individual that they deserve the best in life.

16. A resonance based sales method comprising:
a) providing a skin care and/or cosmetic product including natural ingredients;
b) providing a package configured for association with the product; and
c) providing an engaging message associated with one or more of the product and the package, the engaging message configured to elicit an emotional response of inspiration from a customer, wherein the emotional response is representative of the engaging message resonating with one or more aspects of a female archetype.

17. The method according to claim 16, wherein the engaging message is configured to identify one or more positive elements or traits of the individual.

18. The method according to claim 16, wherein the engaging message is presented in a first person plural format.

19. The method according to claim 16, wherein the engaging message is associated with the package and the product.

20. The method according to claim 16, wherein a first engaging message is associate with the package and a second engaging message is associated with the product.
